(19) United States
(12) Patent Application Publication
(10) Pub. No.: US 2009/0133953 A1
(43) Pub. Date: May 28, 2009

(54) POWER STEERING SYSTEM HAVING A VARIABLE-RATIO DRIVE MECHANISM FOR A VEHICLE

(75) Inventors: Martin P. Sheridan, Saginaw, MI (US); Albert C. Wong, Saginaw, MI (US); James L. Davison, Freeland, MI (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 11/946,587

(22) Filed: Nov. 28, 2007

(51) Int. Cl. B62D 5/06; F16H 57/08; G06F 19/00

(52) U.S. Cl. 180/421; 475/347; 701/41

(57) ABSTRACT

A power steering system for translating movement to a pair of wheels of a vehicle having an engine is disclosed. The system includes a steering assembly adapted for coupling engagement to the wheels for turning the wheels. The system includes a hydraulic pump having a pump input and a pump output and is coupled to the steering assembly and a planetary gear set. The system also includes a steering shaft operatively connected to the hydraulic pump for controlling a direction of the pump output and coupled to the steering assembly. The system further includes a variable-ratio drive mechanism having an electric motor and a controller. The electric motor is coupled to the planetary gear set and the controller communicates with the electric motor for controlling a rotational speed of the planetary gear set to maintain the pump output.

### FIELD OF THE INVENTION

The present invention relates to a power steering system of a vehicle for assisting the steering of the vehicle. More specifically, the present invention relates to a variable-ratio drive mechanism for controlling a hydraulic pump of a power steering system.

### BACKGROUND OF THE INVENTION

Power steering systems for assisting a driver to steer a vehicle are well known in the art. The systems typically include a hydraulic pump having an operating pressure. There are typically two main types of hydraulic pumps used in the art, which are a fixed displacement pump and a variable displacement pump.

Traditionally, an engine having an engine rotational speed is coupled to the hydraulic pump for operating the hydraulic pump. A belt and pulley system is coupled to the engine for transmitting the engine rotational speed to the hydraulic pump for generating the operating pressure within the hydraulic pump. As the engine rotational speed increases, the operating pressure of the hydraulic pump increases and the fixed displacement pump bypasses excess flow internally which expends additional energy. In addition, the variable displacement pump operates in a similar manner as the fixed displacement pump but may reduce the operating pressure incrementally as the engine rotational speed increases. In addition, the variable displacement pump also provides a bypass for excessive operating pressures and tend to be noisier than the fixed displacement pump. The expended energy of the fixed displacement pump and the variable displacement pump is a result of the inability of the power steering system to modify the engine rotational speed prior to transferring the engine rotational speed to the hydraulic pump.

There are power steering systems that modify the engine rotational speed using a planetary gear set. An example of such a power steering system is shown in U.S. Pat. No. 4,505,350 (the '350 patent). The '350 patent discloses a power steering system that reduces the engine rotational speed transmitted to the hydraulic pump for conserving energy. The power steering system includes the hydraulic pump, a planetary gear set, an engine and a transmission. The hydraulic pump has an operating pressure generated by the engine rotational speed. The vehicle includes a plurality of wheels having a wheel rotational speed. The power steering system transmits power to the hydraulic pump through the planetary gear set. The planetary gear set has a gear ratio and includes a sun gear, a ring gear, a plurality of plant gears and a planetary carrier. A belt and pulley system driveably connects the engine to the ring gear for rotating the ring gear. The transmission is driveably connected to the sun gear for transmitting the wheel rotational speed to the planetary gear set. The planetary carrier is coupled to the hydraulic pump either directly or through a one-way clutch.

When the vehicle is stationary, the wheel rotational speed is zero preventing the rotation of the sun gear. The lack of rotation of the sun gear provides a torque reaction for the planetary gear set through which power is transmitted from the ring gear to the planetary carrier and ultimately to the hydraulic pump. When the vehicle is stationary, the hydraulic pump has a maximum operating pressure because the demand for power steering is the greatest while the vehicle is stationary. When the vehicle accelerates or has a constant velocity, the engine rotational speed is offset by the wheel rotational speed through the rotation of the sun gear to decrease the rotation of the planetary carrier and ultimately the hydraulic pump.

However, due to the gear ratio being fixed, the wheel rotational speed may negate the engine rotational speed preventing the hydraulic pump from generating a pressure. Additionally, the method disclosed in the '350 patent is limited to the relationship of the engine speed, the wheel rotational speed and the gear ratio of the planetary gear set. Therefore, the power steering system disclosed in the '350 patent lacks the ability to differentiate between an accelerating vehicle and a non-accelerating vehicle at a given speed, which could result in large fluctuation in the flow generated in the hydraulic pump and wasted energy. Additionally, none of the fixed displacement pump, the variable displacement pump nor the power steering system disclosed in the '350 patent account for the instantaneous demand of the power steering system and are unable to adjust the operating pressure of the hydraulic pump accordingly.

Therefore, there remains a need to provide a power steering system that continuously controls an operating pressure of a hydraulic pump for obtaining efficient operating pressure to increase fuel economy while maintaining a minimum operating pressure to ensure the power steering system is constantly provided.

### SUMMARY OF THE INVENTION AND ADVANTAGES

The present invention relates to a power steering system for translating movement of a steering wheel to a pair of wheels of a vehicle having an engine. The power steering system includes a steering shaft and a steering assembly. The steering shaft is coupled to the steering assembly for transmitting the rotation of the steering shaft to the steering assembly. The steering assembly is adapted for coupling engagement to the wheels for turning the wheels in respect to the rotation of the steering shaft.

The power steering system further includes a hydraulic pump coupled to the steering shaft and having a pump input and a pump output. The pump output defines an operating pressure within a predetermined range of pump pressures. The steering shaft is operatively connected to the pump output between the hydraulic pump and the steering assembly for controlling a direction of the pump output to assist in turning the wheels.

A planetary gear set is operatively coupled to the pump input and includes a first gear input, a second gear input and a gear output with the gear output. A variable-ratio drive mechanism includes a controller and an electric motor. The controller senses a rotational speed of the second gear input and communicates with the electric motor for controlling the rotational speed of the electric motor. The electric motor has a rotational speed and is coupled to the first gear input for transmitting the rotation speed of the electric motor to the planetary gear set. The electric motor controls the rotational speed of the gear output for maintaining the operating pressure of the pump output between the predetermined ranges of pump pressures based on the rotational speed of the second gear input.

Therefore, the present invention provides for a power steering system that significantly increases the efficiency of the hydraulic pump by modifying the operating pressure of the hydraulic pump through the electric motor controlled by the communication with the controller to increase the fuel economy of the vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a power steering system mounted to a steering assembly;

FIG. 2 is a partial cross-sectional side view of a first embodiment of a variable-ratio drive mechanism with an electric motor coupled to a planetary carrier and a hydraulic pump coupled to a sun gear;

FIG. 3 is a partial cross-sectional side view of a second embodiment of a variable-ratio drive mechanism with the electric motor coupled to the planetary carrier and the hydraulic pump coupled to a ring gear; and

FIG. 4 is a partial cross-sectional side view of a third embodiment of a variable-ratio drive mechanism with the electric motor coupled to the ring gear and the hydraulic pump coupled to the planetary carrier.

### DETAILED DESCRIPTION OF THE INVENTION

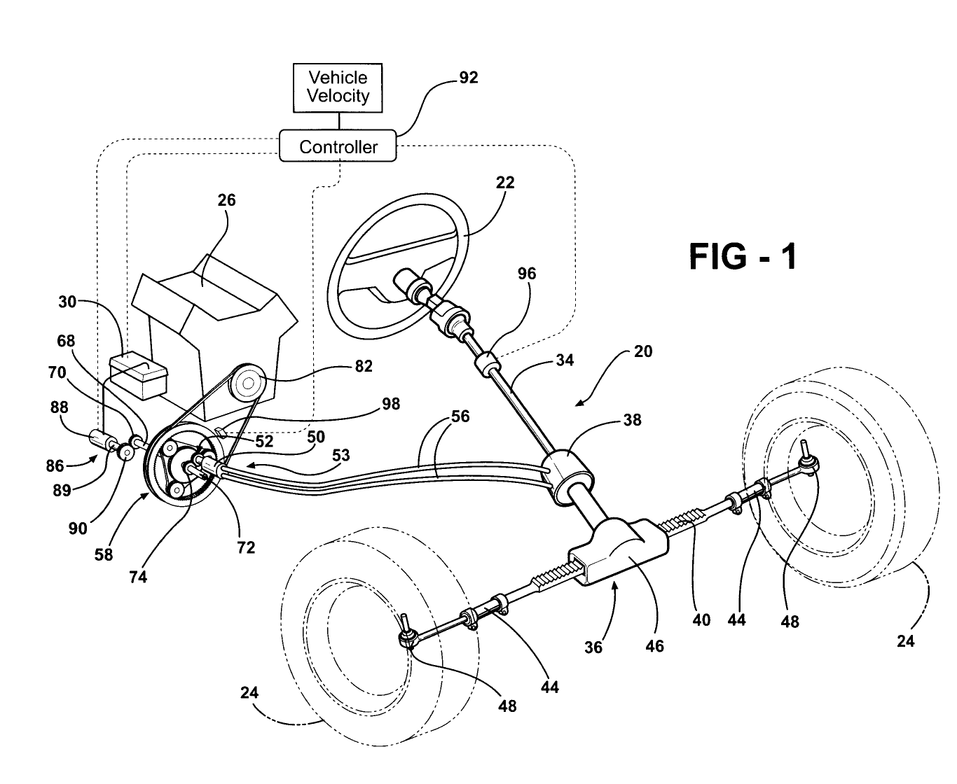

Referring to the Figures, wherein like numerals indicate like or corresponding parts throughout the several views, a power steering system 20 for translating movement of a steering wheel 22 to a pair of wheels 24 of a vehicle (not shown) is generally shown in FIG. 1.

The vehicle includes an engine 26 having an engine rotational speed and a battery 30. An engine axle rod (not shown) is coupled to and extends from the engine 26 for rotating at the engine rotational speed as will be discuss in detail below.

The power steering system 20 includes a steering shaft 34 and a steering assembly 36 coupled to the steering shaft 34. It is to be appreciated that the steering shaft 34 may be a single shaft or a plurality of shafts coupled together in multiple segments. The steering wheel 22 is coupled to the steering shaft 34 disposed in a passenger compartment (not shown) of the vehicle for allowing a user (not shown) to rotate the steering wheel 22 which rotates the steering shaft 34 to turn the wheels 24. The rotation of the steering shaft 34 defines a demand on the power steering system 20. The demand increases when the steering shaft 34 is rotated and decreases when the steering shaft 34 is stationary. A rotary valve 38 is disposed on the steering shaft 34 for assisting with the rotation of the steering shaft 34. It is to be appreciated that the rotary valve 38 may be coupled to the steering assembly 36 for assisting with the movement of the steering assembly 36 based on the rotation of the steering shaft 34.

The steering assembly 36 includes a toothed rack 40, a pinion gear (not shown) and a pair of tie rods 44 coupled to the toothed rack 40. However, it is to be appreciated that the subject invention could be used with any type of steering assembly 36 without deviating from the present invention. Additionally, it is to be appreciated that the steering assembly 36 is adapted for coupling engagement to the wheels 24 for turning the wheels 24. There are various ways to accomplish this as known in the industry without deviating from the present invention.

The pinion gear is disposed on the steering shaft 34 and coupled to the steering assembly 36 for coupling the steering shaft 34 to the steering assembly 36. The steering assembly 36 further includes a housing 46 with the pinion gear coupled to the toothed rack 40 within the housing 46 for transmitting the rotation of the steering shaft 34 to move the steering assembly 36. A pair of steering knuckles 48 are coupled between the tie rods 44 and the wheels 24 for translating the movement of the steering assembly 36 to turn the wheels 24. This type of steering assembly 36 is well known in the industry and will therefore not be discussed in any greater detail.

The power steering system 20 further includes a hydraulic pump 50 having a pump input 52 and a pump output 53 with the pump output 53 defining an operating pressure within a predetermined range of pump pressures. It is to be appreciated that the pump output may be defined as a flow that is generated by the operating pressure. In the illustrated embodiment, the pump input 52 is further defined as a pump axle rod 54 extending from the hydraulic pump 50 with a pump gear 55 disposed on the pump axle rod 54. The pump axle rod 54 has a rotational speed for generating the operating pressure of the hydraulic pump 50. The operating pressure is a fluid pressure. The operating pressure is directly related to the rotational speed of the pump input 52.

The range of operating pressures is determined by calculating a maximum operating pressure and a minimum operating pressure. The maximum operating pressure is determined by calculating the required operating pressure to generate assistance in rotating the steering shaft 34 by the rotary valve 38 while the vehicle is stationary. As the vehicle velocity increases, the operating pressure required to assist in rotating the steering shaft 34 decrease. The operating pressure may then be lowered to the minimum pressure that will allow the power steering system 20 to respond when the demand for assistance increases without delay. This ensures that the user will not feel the effects of the changes in the operating pressure.

The hydraulic pump 50 is coupled to the steering shaft 34 through the rotary valve 38. It is to be appreciated that the hydraulic pump 50 may be of any type of hydraulic pump 50 known to those of ordinary skill in the art such as a fixed displacement hydraulic pump or a variable displacement hydraulic pump without deviating from the subject invention.

A plurality of fluid hoses 56 are coupled to the hydraulic pump 50 and the rotary valve 38 for transporting the operating pressure generated by the hydraulic pump 50 to the rotary valve 38. The steering shaft 34 is operatively connected to the pump output 53 between the hydraulic pump 50 and the steering assembly 36 for controlling a direction of the pump output 53 and to turn the wheels 24. More specifically, the rotary valve 38 operatively connects the steering shaft 34 to the pump output 53. The rotary valve 38 operatively transmits the pump output 53 to the steering shaft 34 in the direction determined by the rotation of the steering shaft 34 for moving the steering assembly 36 and ultimately the wheels 24. It is to be appreciated that the rotary valve 38 may transmit the pump output 53 directly to the steering assembly 36 without deviating from the present invention.

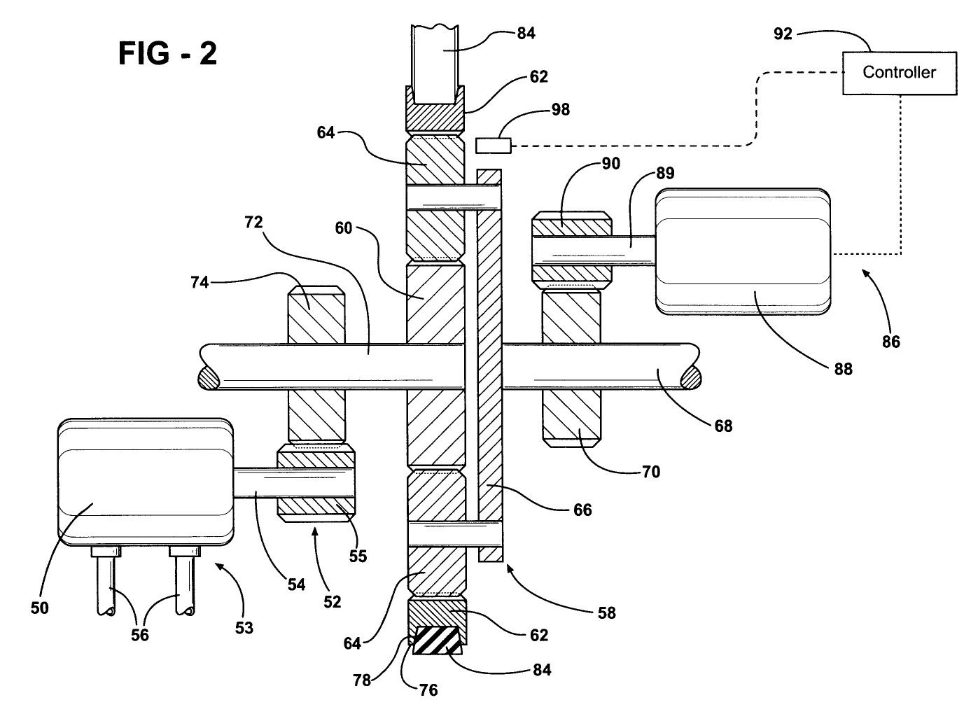

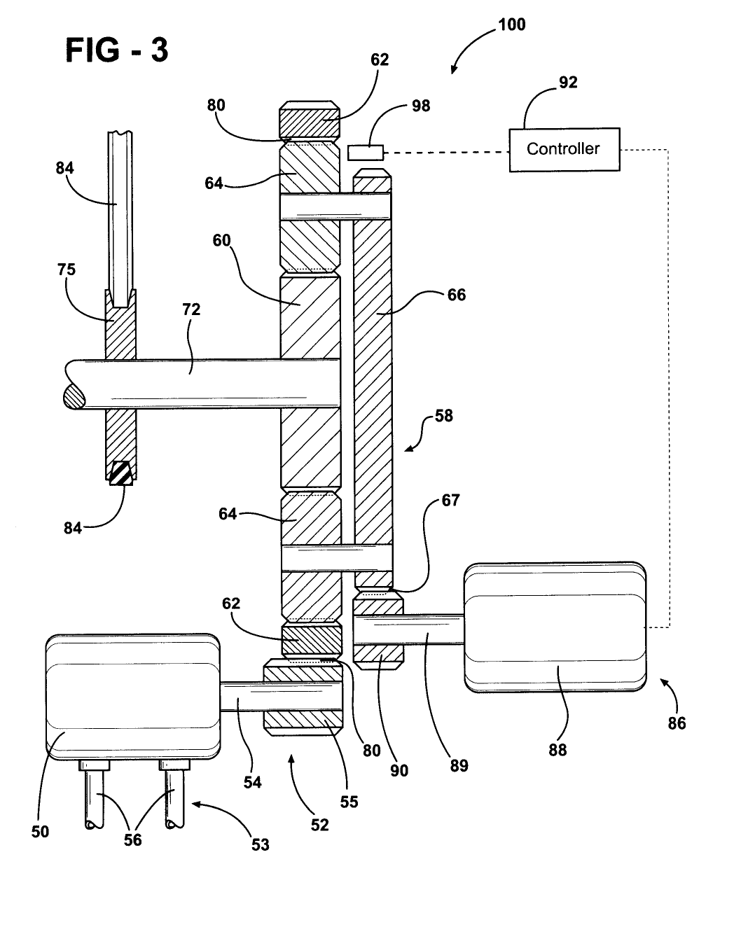

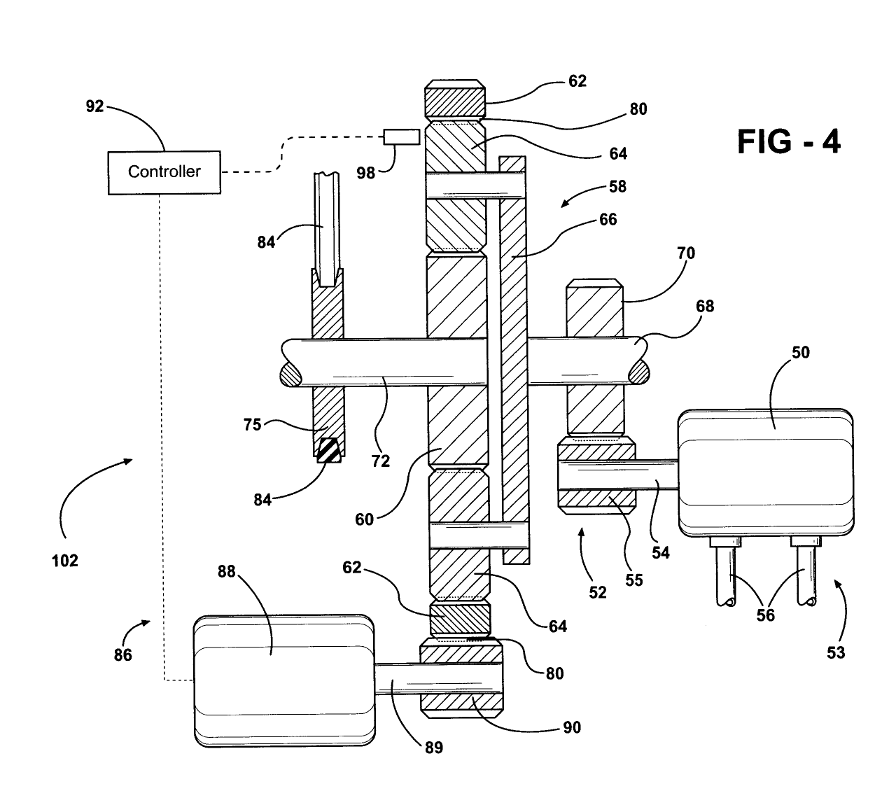

Referring also to FIG. 2, the power steering system 20 further includes a planetary gear set 58 having a sun gear 60, a ring gear 62, a plurality of planetary gears 64 and a planetary carrier 66. The sun gear 60, the ring gear 62 and the planetary gears 64 are coupled to one another and the planetary carrier 66 is coupled to the planetary gears 64. The sun gear 60, the ring gear 62 and the planetary carrier 66 each have a rotational speed. It is to be appreciated that the planetary carrier 66 may also be defined as a planetary spider as known to those of ordinary skill in the art. It is also to be appreciated that the planetary carrier 66 may have a first plurality of teeth 67 for meshing with an other gear as shown in FIG. 3. A carrier axle rod 68 is coupled to the planetary carrier 66 for transmitting the rotational speed of the planetary carrier 66. A carrier gear 70 is disposed on the carrier axle rod 68. It is to be appreciated that the carrier gear 70 may be a carrier pulley as know to those of ordinary skill in the art. A sun axle 72 is coupled to the sun gear 60 for transmitting the rotation speed of the sun gear 60 with a sun axle gear 74 is disposed on the sun axle 72. It is to be appreciated that the sun axle gear 74 may be a sun pulley 75 as shown in FIGS. 3 and 4 and as know to those of ordinary skill in the art. The ring gear 62 includes an outer surface 76 defining a channel 78. It is to be appreciated that the ring gear 62 may have a second plurality of teeth 80 disposed about the outer surface 76 of the ring gear 62 for meshing with an other gear as shown in FIGS. 3 and 4.

In the broadest sense, the planetary gear set 58 includes a first gear input, a second gear input and a gear output. The first gear input is defined as at least one of the sun gear 60, the ring gear 62 and the planetary carrier 66. The second gear input is defined as an other one of the sun gear 60, the ring gear 62 and the planetary carrier 66. The gear output is therefore defined as an other one of the sun gear 60, the ring gear 62 and the planetary carrier 66 and is operatively coupled to the pump input 52. In other words, any one of the first gear input, second gear input and gear output may be coupled to any of the sun gear 60, the ring gear 62 and the planetary carrier 66 in any combination without deviating from the present invention.

An engine pulley 82 is disposed on the engine axle rod with a belt 84 coupled to the engine pulley 82 and the second gear input of the planetary gear set 58 for transmitting the engine rotational speed to the second gear input. As mentioned above, the second gear input may be any one of the sun gear 60, the ring gear 62 and the planetary carrier 66 and the orientation of coupling the belt 84 to the planetary gear set 58 will be discussed below. It is to be appreciated that the belt 84 may be coupled to additional pulleys to provide power to other components of the vehicle.

The power steering system 20 also includes a variable-ratio drive mechanism 86 having an electric motor 88 that communicates with the battery 30 of the vehicle for providing power to the electric motor 88. The electric motor 88 has a rotational speed and is coupled to the first gear input of the planetary gear set 58 for controlling the rotational speed of the first gear input. The rotational speed of the first gear input is determined in relation to the rotational speed of the second gear input for controlling the rotational speed of the gear output for maintaining the operating pressure of the hydraulic pump 50. The electric motor 88 includes a motor axle rod 89 extending from the electric motor 88 for transmitting the rotational speed of the electric motor 88. A motor gear 90 is disposed on the motor axle rod 89 and is spaced from the electric motor 88. The electric motor 88 is coupled to the first gear input of the planetary gear set 58 for transmitting the rotational speed of the electric motor 88 to the first gear input.

The variable-ratio drive mechanism also includes a controller 92 coupled to and communicating with the electric motor 88 for controlling the rotational speed of the electric motor 88. The controller 92 is connected to the battery 30 for providing power to the controller 92. The controller 92 calculates the rotational speed of the electric motor 88 based on a set of variables. As the rotational speed of the electric motor 88 changes, the gear ratio of the planetary gear set 58 changes which results in a change of the rotational speed of the gear output. By controlling the rotational speed of the gear output, the pump input 52 is controlled and consequently the operating pressure of the hydraulic pump 50 is controlled. The set of variables may include, but are not limited to, a vehicle velocity, a rotation of the steering shaft 34 and the rotational speed of the second gear input. It is to be appreciated that additional variables may be communicated to the controller 92.

A torque sensor 96 is coupled to the steering shaft 34 for sensing the rotation of the steering shaft 34. It is to be appreciated that there are alternative ways of sensing the rotation of the steering shaft 34 without deviating from the present invention. The torque sensor 96 communicates with the controller 92 for transmitting information about the rotation of the steering shaft 34 to the controller 92. A speed sensor 98 is coupled to the second gear input for sensing the rotational speed of the second gear input. The speed sensor 98 communicates with the controller 92 for transmitting information about the rotational speed of the second gear input to the controller 92. The vehicle velocity is communicated to the controller 92 by any way known by those of ordinary skill in the art.

It is to be appreciated that there are various ways to communicate the battery 30, the torque sensor 96, and the speed sensor 98 with the controller 92 without deviating from the subject invention. It is to be further appreciated that the speed sensor 98 may be coupled to the engine 26 and directly transmit the engine rotational speed to the controller 92 and the controller 92 may be programmed to calculate the rotational speed of the second gear input based on the engine rotational speed.

Below is a general discussion of the first embodiment of the power steering system 20, which is for illustrative purposes only. For this embodiment, the first gear input is defined as the planetary carrier 66, the second gear input is defined as the ring gear 62 and the output gear is defined as the sun gear 60 as shown in FIGS. 1 and 2.

The motor gear 90 of the electric motor 88 is coupled to the carrier gear 70 of the carrier axle rod 68 for transmitting the rotational speed of the electric motor 88 to the carrier axle rod 68 to vary the gear ratio of the planetary gears 64. It is to be appreciated that the motor axle rod 89 may be defined as the carrier axle rod 68 for eliminating the carrier gear 70 and the motor gear 90. The sun gear 60 is coupled to the hydraulic pump 50 by coupling the sun axle gear 74 and the pump gear 55. It is to be appreciated that the pump axle may be defined as the sun axle 72 for directly connecting the sun gear 60 to the hydraulic pump 50 and thus eliminating the sun axle gear 74 and the pump gear 55.

The belt 84 is disposed around the engine pulley 82 and the ring gear 62 for transmitting the engine rotational speed to the planetary gear set 58. As the engine rotational speed is transmitted to the ring gear 62 by the belt 84, the speed sensor 98 continuously senses the rotational speed of the ring gear 62 and communicates that information to the controller 92. Simultaneously, the torque sensor 96 senses the rotation of the steering shaft 34 with the vehicle velocity and the rotation of the steering shaft 34 communicating with the controller 92.

The controller 92 communicates with the electric motor 88 for controlling the rotational speed of the electric motor 88. The controller 92 having received the set of variables then calculates the rotational speed of the electric motor 88 necessary to achieve the proper operating pressure. The electric motor 88 being coupled to the planetary carrier 66 causes the planetary carrier 66 to rotate for changing the gear ratio of the planetary gear set 58. As the gear ratio changes, the rotational speed of the sun gear 60 changes. The sun gear 60 being coupled to the hydraulic pump 50 in turn rotates the hydraulic pump 50 to generate the operating pressure calculated by the controller 92. The use of the electric motor 88 may instantaneously and continuously vary the gear ratio based on the variables collected by the controller 92 and the resulting calculations of the controller 92. This process is repeated constantly to ensure the hydraulic pump 50 only generates the most efficient operating pressure based on the set of variables for conserving energy and increasing fuel economy.

A significant advantage of the present invention is the reduction of the operating pressure as the velocity of the vehicle increases for conserving energy and increasing fuel economy. Additionally, the power steering system 20 may reduce the operating pressure while the steering shaft 34 is stationary and then increase the operating pressure as the steering shaft 34 is rotated to assist in the rotation of the steering shaft 34. The result of this is an increase in efficiency as compared to systems that constantly maintain the operating pressure independent of the demand on the system.

Referring to FIG. 3, a second embodiment of a variable-ratio drive mechanism 100, wherein like numerals indicate like or corresponding parts throughout the views, is generally shown. All the features of the system discussed above apply to this embodiment. The primary distinction between the first embodiment and the second embodiment is the orientation of the hydraulic pump 50. Further, this embodiment eliminates the carrier axle rod 68.

In the second embodiment the first gear input is defined as the planetary carrier 66, the second gear input is defined as the sun gear 60 and the gear output is defined as the ring gear 62. The planetary carrier 66 includes the first teeth 67 for engaging the motor gear 90 of the electric motor 88. The rotational speed of the electric motor 88 is transmitted to the planetary gear. The sun gear 60 is further defined as the sun pulley 75. The belt 84 is coupled to the engine pulley 82 and sun pulley 75 in a similar manor as the previous embodiment for transmitting the engine rotational speed to the sun gear 60. The speed sensor 98 is coupled to the sun gear 60 for communicating the rotational speed of the sun gear 60 to the controller 92. The ring gear 62 includes the second teeth 80 coupled to the pump gear 55 for transmitting the rotational speed of the ring gear 62 to the hydraulic pump 50 to generate the operating pressure.

Referring to FIG. 4 a third embodiment of a variable-ratio drive mechanism 102, wherein like numerals indicate like or corresponding parts throughout the views, is generally shown. All the features of the system discussed above apply to this embodiment. The primary distinction between the first and second embodiment and the third embodiment is the orientation of the hydraulic pump 50 and the electric motor 88.

In the third embodiment the first gear input is defined as the ring gear 62, the second gear input is defined as the sun gear 60 and the output gear is defined as the planetary carrier 66. The ring gear 62 has the second teeth 80 coupled to the motor gear 90 for transmitting the rotational speed of the electric motor 88 to the ring gear 62. The sun gear 60 is further defined as the sun pulley 75. The belt 84 is coupled to the engine pulley 82 and sun pulley 75 in a similar manor as the previous embodiment for transmitting the engine rotational speed to the sun gear 60. The speed sensor 98 is coupled to the sun gear 60 for communicating the rotational speed of the sun gear 60 to the controller 92. The carrier axle rod 68 gear is coupled to the pump gear 55 for transmitting the rotational speed of the planetary carrier 66 to the hydraulic pump 50 to generate the operating pressure. It is to be appreciated that the carrier axle rod 68 may be the pump input 52 for eliminating the need for the pump axle, the carrier axle rod 68 gear and the pump gear 55.

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention may only be determined by studying the following claims.

What is claimed is:

1. A power steering system for translating movement of a steering wheel to a pair of wheels of a vehicle having an engine, said system comprising:
a steering assembly adapted for coupling engagement to the wheels to turn the wheels in respect to rotation of a steering wheel;
a hydraulic pump having a pump input and a pump output with said pump output defining an operating pressure within a predetermined range of pump pressures and coupled to said steering assembly;
a steering shaft operatively connected to said pump output between said hydraulic pump and said steering assembly for controlling a direction of said pump output and to turn the wheels;
a planetary gear set having a first gear input, a second gear input and a gear output with said gear output operatively coupled to said pump input; and
a variable-ratio drive mechanism having an electric motor and a controller with said electric motor coupled to said first gear input and said controller in communication with said electric motor and sensing a rotational speed of said second gear input, and said electric motor controlling a rotational speed of said gear output to maintain said operating pressure at said pump output between said predetermined range of pump pressures based on the rotational speed of said second gear input.

2. A system as set forth in claim 1 wherein said planetary gear set includes a sun gear, a ring gear, a plurality of planetary gears and a planetary carrier with said sun gear, said ring gear and said planetary gears coupled to one another and said planetary carrier is coupled to said planetary gears.

3. A system as set forth in claim 2 wherein said first gear input is further defined as at least one of said sun gear, said ring gear and said planetary carrier with said second gear input further defined as an other one of said sun gear, said ring gear and said planetary carrier and said gear output is further defined as an other one of said sun gear, said ring gear and said planetary carrier.

4. A system as set forth in claim 3 wherein said first gear input is further defined as said planetary carrier with said second gear input defined as at least one of said sun gear and said ring gear and said gear output is defined as an other one of said sun gear and said ring gear.

5. A system as set forth in claim 4 wherein said first gear input is further defined as said planetary carrier, said second gear input is defined as said ring gear and said output gear is defined as said sun gear.

6. A system as set forth in claim 4 wherein said first gear input is further defined as said planetary gear carrier, said second gear input is defined as said sun gear and said gear output is defined as said ring gear.

7. A system as set forth in claim 3 wherein said first gear input is further defined as said ring gear with said second gear input defined as at least one of said sun gear and said planetary carrier and said gear output is defined as an other one of said sun gear and said planetary carrier.

8. A system as set forth in claim 7 wherein said first gear input is further defined as said ring gear, said second gear input is defined as said sun gear and said output gear is defined as said planetary carrier.

9. A system as set forth in claim 1 wherein said controller receives a velocity of the vehicle and is coupled to said steering shaft for sensing a rotation of said steering shaft to control the rotational speed of said gear output.

10. A system as set forth in claim 9 further defining a torque sensor coupled to said steering shaft associated with said controller for sensing the rotation of said steering shaft to control the rotational speed of said gear output.

11. A system as set forth in claim 1 wherein said pump input is further defined as a mechanical coupling.

12. A system as set forth in claim 1 wherein said pump output is further defined as a fluid pressure.
